(19) United States
(12) Patent Application Publication
(10) Pub. No.: US 2008/0244035 A1
(43) Pub. Date: Oct. 2, 2008

(54) REMOTE COPY SYSTEM AND REMOTE COPY METHOD

(75) Inventor: NORIAKI HORIE, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 12/051,424

(22) Filed: Mar. 19, 2008

(30) Foreign Application Priority Data
Mar. 30, 2007 (JP) 2007-091480

(51) Int. Cl. G06F 15/16

(52) U.S. Cl. 709/217

(57) ABSTRACT

In a remote copy method, a delay in data update processing in a primary volume is eliminated. The method employs at least one of a synchronous method in which the data of a primary volume is updated after being confirmed that the data has been copied into a secondary volume and an asynchronous method in which the data of the primary volume is updated before being confirmed that the data has been copied into the secondary volume. The data of the primary volume is updated by a command from the higher-level host, and, when the updated data is copied into the secondary volume, a response time that is the time taken to copy the data into the secondary volume is monitored. At this time, the synchronous method is employed, and, when the response time being monitored exceeds a fixed time, the asynchronous method is employed instead of the synchronous method.

### CROSS-REFERENCE TO RELATED APPLICATION

This application is based upon and claims the benefit of priority from Japanese patent application No. 2007-091480, filed on Mar. 30, 2007, the disclosure of which is incorporated herein in its entirety by reference.

### BACKGROUND OF THE INVENTION

1. Field of the Invention

The present invention relates to a remote copy system and a remote copy method.

2. Description of the Related Art

A remote copy method according to which a copy of data is made between disk array units is known. In the remote copy method, a disk array unit disposed in a local site (i.e., a copy source site) is connected to a disk array unit disposed in a remote site (i.e., a copy destination site) through a communication line. The disk array unit of the local site has a primary volume, whereas the disk array unit of the remote site has a secondary volume. Generally, the remote copy method of copying data of the primary volume into the secondary volume is roughly divided into two types, i.e., a synchronous method and an asynchronous method.

In the synchronous method, when a write request to write updated data is issued from a higher-level host to a primary volume disposed in a local site and if what is requested is to perform a remote copy operation, the writing of the updated data into a secondary volume is first completed, and then the higher-level host of the local site is informed of the completion of the write operation. Therefore, although data consistency is always secured, a response delay will occur in the disk array unit of the local site because of a transmission delay if both sites are distant from each other or if the capacity of a communication line extending between the disk array units is small.

In the asynchronous method, when a write request to write updated data is issued from a higher-level host to a primary volume disposed in a local site and if what is requested is to perform a remote copy operation, the higher-level host of the local site is informed of the completion of the write operation when the writing of the updated data into the primary volume is completed. On the other hand, the writing of the updated data into the secondary volume of the remote site is asynchronously performed in accordance with the capacity of the communication line. Therefore, the writing of the updated data is completed in a processing time required in the local site side, and hence a response delay caused by data transfer toward the remote site does not occur. Concerning updated information of the primary volume, only a piece of information showing a specific address where data has been written is managed in a difference information storage section. Based on this information, pieces of data are sent to the secondary volume one by one without securing the temporal write order of updated data. Therefore, if there is a difference therebetween, data of the primary volume has no consistency, and hence it becomes impossible to secure a recovery using the secondary volume, for example, when a disaster occurs.

The following process is employed to secure data consistency. If a write request to write updated data is issued from a higher-level host disposed in a local site, the higher-level host of the local site is informed of the completion of the writing of the data when the data is written into a dedicated storage buffer in synchronization with this write processing. The dedicated storage buffer stores the pieces of updated data in order of the writing of the pieces of updated data sent from the higher-level host. Thereafter, the pieces of updated data stored therein are packed and transmitted to a disk array unit disposed in the remote site. The disk array unit of the remote site writes the updated data to the secondary volume based on the packed data received therefrom.

Japanese Published Unexamined Patent Application No. 2006-236019 (Patent Literature 1) describes a method of switching between the synchronous/asynchronous modes of the data copy method as follows. In a remote data copy operation between storage devices, there is a case in which uselessness is caused in a storage area capacity used as a temporary storage area in the storage device. Therefore, in a system including a management computer, a first storage device, and a second storage device, a change in the amount of access from a host computer to the first storage device is monitored when the second storage device is allowed to maintain copy data of the first storage device by a remote data copy operation. According to this monitoring, the management computer emits a command to the storage device to perform switching between the synchronous/asynchronous modes of the remote data copy method.

A first problem is as follows. When the synchronous method is performed, a response delay will occur in the disk array unit of the local site because of a transmission delay if both sites are distant from each other or if the communication line between disk array units is small in capacity. Therefore, the communication line, through which the disk array unit of the local site is connected to the disk array unit of the remote site, is required to have a line band that can allow maximum I/O processing that does not cause a response delay when the I/O traffic of updated data from the higher-level host to the disk array unit of the local site is increased.

A second problem is as follows. When the synchronous method is performed, a copy operation is forcedly stopped so as to prevent a response delay of the disk array unit of the local site if I/O traffic exceeding an assumed tolerance established when the system is designed is caused from the higher-level host, and, as a result, a response delay occurs because of a line band shortage.

A third problem is as follows. When the asynchronous method is performed, there is a need to achieve complete synchronization by temporarily stopping an input/output operation with respect to the disk array unit of the local site and by copying the primary volume of the local site to the secondary volume of the remote site based on the stopped point of time, in order to secure data consistency.

A fourth problem is as follows. When the asynchronous method is performed, a remote copy operation causes the occurrence of a wait for an empty state of a dedicated storage buffer when the buffer is overflowed, and, after all, a transmission delay occurs due to the distance between both sites and the capacity of the communication line in the same way as in the synchronous method.

The problem of Patent Literature 1 resides in the fact that switching between the synchronous/asynchronous modes of the data copy method is performed based on a change in the amount of access from the host computer to a first storage device. In other words, an increase in the amount of access from the host computer to the first storage device does not necessarily lead to a response delay caused by a line band shortage. Therefore, even if switching between the synchronous/asynchronous modes is performed based on a change in the amount of access, it is difficult to solve the problem of the response delay caused by the line band shortage.

### SUMMARY OF THE INVENTION

It is therefore an exemplary object of the invention to provide a remote copy method between disk array units with high reliability. It is another exemplary object of the invention to provide a fault-tolerant remote copy method that is based on a synchronous method and that can endure a temporary I/O traffic increase during a remote copy operation which exceeds an assumed tolerance established when the system is designed.

To achieve the objects, in a remote copy system according to an exemplary aspect of the invention, updated data is written into a primary volume of a local site, and data written in the primary volume is copied into a secondary volume of a remote site by making combination use of a synchronous method according to which updated data is written and copied while synchronizing the primary volume of the local site with the secondary volume of the remote site and an asynchronous method according to which updated data is written and copied under an asynchronous state between the primary volume and the secondary volume. The remote copy system includes a main controller that performs control to write updated data into the primary volume and a sub-controller that performs control to write data of the primary volume into the secondary volume. The main controller performs switching from the synchronous method to the asynchronous method when a data write time taken to write data into the secondary volume exceeds a predetermined value. According to a difference between a data amount of the primary volume and a data amount of the secondary volume, the main controller controls combination use of the synchronous method and the asynchronous method and switching from the asynchronous method to the synchronous method. The sub-controller controls a copy operation performed to copy the updated data under control performed by the main controller.

In a remote copy method according to another exemplary aspect of the invention, updated data is written into a primary volume of a local site, and data written in the primary volume is copied into a secondary volume of a remote site by making combination use of a synchronous method according to which updated data is written and copied while synchronizing the primary volume of the local site with the secondary volume of the remote site and an asynchronous method according to which updated data is written and copied under an asynchronous state between the primary volume and the secondary volume. In the remote copy method, switching from the synchronous method to the asynchronous method is performed when a data write time taken to write data into the secondary volume exceeds a predetermined value. In the remote copy method, combination use of the synchronous method and the asynchronous method and switching from the asynchronous method to the synchronous method are controlled according to a difference between a data amount of the primary volume and a data amount of the secondary volume.

### BRIEF DESCRIPTION OF THE DRAWINGS

FIG. 1 is a block diagram showing the outline of an exemplary embodiment of a disk array controller and a disk array system according to the invention.

FIG. 2 is a block diagram showing an example of the hardware structure of a disk array unit shown in FIG. 1.

FIG. 3 is a block diagram showing an example of a function concerning the remote copy of a controller shown in FIG. 2.

FIG. 4 is a flow chart showing an example (first example) of an operation concerning the remote copy of a controller shown in FIG. 3.

FIG. 5 is a flow chart showing an example (second example) of an operation concerning the remote copy of the controller shown in FIG. 3.

### DESCRIPTION OF THE EXEMPLARY EMBODIMENT

An exemplary embodiment of the invention will be hereinafter described with reference to the attached drawings.

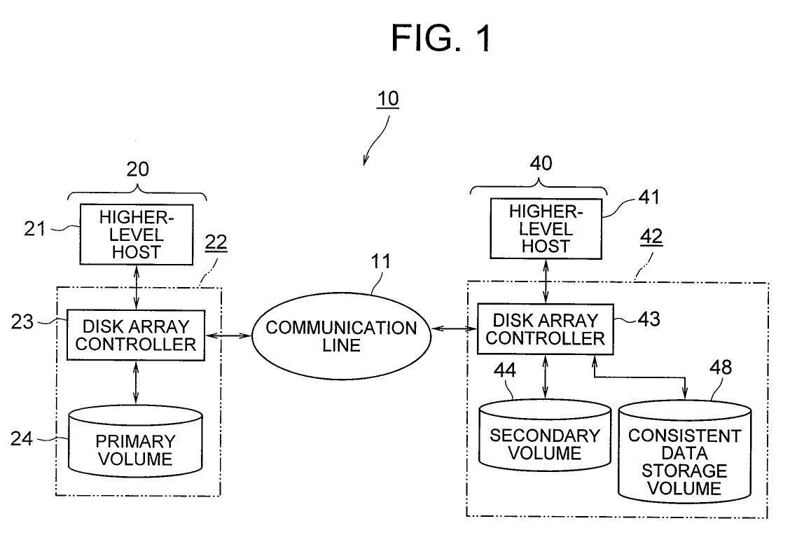

As shown in FIG. 1, the exemplary embodiment of the invention is aimed at a remote copy system in which updated data is written into a primary volume 24 of a local site 20, and the data written in the primary volume 24 is copied into a secondary volume 44 of a remote site 40 by using a synchronous method in which updated data is written and copied by synchronizing the primary volume 24 of the local site 20 with the secondary volume 44 of the remote site 40 in combination with an asynchronous method in which updated data is written and copied in an asynchronous state between the primary volume 24 and the secondary volume 44.

In the exemplary embodiment of the present invention, the control of switching between the synchronous method and the asynchronous method is performed based on a data write time (response time) required when the data written in the primary volume 24 is written into the secondary volume 44, not based on access frequency to write updated data into the primary volume 24 of the local site 20.

In other words, as shown in FIG. 1, the exemplary embodiment of the invention includes a main controller 22 that performs control to write updated data into the primary volume 24 and a sub-controller 42 that performs control to write the data of the primary volume 24 into the secondary volume 44. The main controller 22 performs switching from the synchronous method to the asynchronous method when the data write time taken to write the data into the secondary volume 44 exceeds a predetermined value, and controls the combination of the synchronous method and the asynchronous method or switching from the asynchronous method to the synchronous method in accordance with a difference between the amount of data of the primary volume 24 and the amount of data of the secondary volume 44. The sub-controller 42 serves to control the data copy operation under the control performed by the main controller 20.

In the exemplary embodiment of the invention, the main controller 22 performs switching from the synchronous method to the asynchronous method when the data write time taken to write the data into the secondary volume 44 exceeds a predetermined value, and controls the combination of the synchronous method and the asynchronous method or switching from the asynchronous method to the synchronous method in accordance with a difference between the amount of data of the primary volume 24 and the amount of data of the secondary volume 44.

More specifically, the main controller 22 performs switching from the synchronous method to the asynchronous method if the main controller 22 is not informed of the completion of the writing from the secondary volume 44 during a predetermined time. This predetermined time is set according to the ability of the secondary volume 44 to write (copy) the data written into the main volume 24 and according to the traffic capacity of the communication line 11 through which the main controller 22 and the sub-controller 42 are connected together. The predetermined time depends on the data write characteristic of the secondary volume 44 and the traffic capacity of the communication line 11, and is not fixed in anunambiguous manner.

The sub-controller 42 may store the data of the secondary volume 42 in the synchronous mode immediately before being changed to the asynchronous mode in, for example, a consistent data storage volume 48 when the main controller 22 controllably performs switching from the synchronous method to the asynchronous method. Preferably, when the sub-controller 42 saves and stores the data of the secondary volume 42, this data is stored in the form of a data image.

When data is copied from the primary volume 24 to the secondary volume 44, the main controller 22 performs switching from the synchronous method to the asynchronous method, thereafter detects that a data difference between the primary volume 24 and the secondary volume 44 has become smaller than a predetermined amount, thereafter writes updated data into the primary volume 24 according to the synchronous method, and performs parallel processing according to the synchronous method and the asynchronous method until the data difference becomes zero. The predetermined amount is set according to the ability to write (copy) the data written into the main volume 24 and according to the traffic capacity of the communication line 11 through which the main controller 22 and the sub-controller 42 are connected together. The predetermined amount depends on the data write characteristic of the secondary volume 44 and the traffic capacity of the communication line 11, and is not fixed in an unambiguous manner.

For example, the sub-controller 42 may delete the data stored in the consistent data storage volume 48 when a data difference between the primary volume 24 and the secondary volume 44 becomes zero, and switching from the asynchronous method to the synchronous method is then performed.

As described above, the remote copy system is built up as a whole. However, the present invention is not limited to this. The exemplary embodiment of the invention may be formed as a disk array unit in which each of the main controller 22 and the sub-controller 42 is provided as an individual element.

According to the synchronous method, after the data of the primary volume is updated, the completion of the copying of the updated data into the secondary volume is awaited, and the higher-level host of the local site is informed of the completion of the copy operation, i.e., the completion of the writing of the updated data into the main volume. Therefore, if much time is consumed to copy the data into the secondary volume, the notification of the completion of the copy operation to the higher-level host will be delayed. However, in the exemplary embodiment of the invention, the problem of such a delay is overcome.

In more detail, in the exemplary embodiment of the invention, the data write time taken to copy the data of the main volume into the secondary volume is monitored, and, if this data write time exceeds a predetermined value, i.e., if the copy processing is not completed within a predetermined time, a method for the write processing of the updated data of the main volume and the copy processing of the data of the main volume into the secondary volume is changed from the synchronous method to the asynchronous method. Therefore, in the exemplary embodiment of the invention, the higher-level host of the local site is informed of the completion of the writing of the updated data when the write processing of the updated data into the primary volume is completed, without awaiting the completion of the data copy operation in the secondary volume. Therefore, the higher-level host of the local site can be prevented from being late in being informed of the completion thereof.

Additionally, switching from the synchronous method to the asynchronous method is controllably performed based on a data write time required when data written in the primary volume is copied into the secondary volume, instead of access frequency from the higher-level host to the primary volume.

The access frequency from the higher-level host to the primary volume, which serves as the basis of a switching control operation, does not correspond to the traffic capacity of the communication line through which the main controller and the sub-controller are connected together. The switching control operation based on the access frequency is being performed without paying enough attention to a communication state. Therefore, in order to take account of such a communication state, there is a need to make a design for access frequency according to the band of the communication line.

As described above, in the exemplary embodiment of the invention, the switching operation is controllably performed based on a data write time required when data written in the primary volume is copied into the secondary volume, and hence the switching operation can be controllably performed in accordance with a communication state.

Additionally, in the exemplary embodiment of the invention, switching from the synchronous method to the asynchronous method is performed, thereafter it is detected that a data difference between the primary volume and the secondary volume has become smaller than a predetermined amount, thereafter the writing of updated data into the primary volume is performed according to the synchronous method, and parallel processing according to the synchronous method and the asynchronous method is performed until the data difference becomes zero. Therefore, the switching operation can be controllably performed in consideration of the data write characteristic of the primary volume and that of the secondary volume.

Next, the exemplary embodiment of the invention will be described in more detail based on concrete examples.

The remote copy system according to this exemplary embodiment can be achieved in such a concrete form as shown in FIG. 1 and the other figures. In more detail, in the remote copy system 10 according to the exemplary embodiment of the present invention, a main controller 22 of a local site 20 and a sub-controller 42 of a remote site 40 are connected together through a communication line 11 as shown in FIG. 1. In the local site 20, a higher-level host 21 and the main controller 22 are connected together. In the main controller 22, a disk array controller 23 and a primary volume 24 are connected together. In the remote site 40, a higher-level host 41 and the sub-controller 42 are connected together. In the sub-controller 42, a disk array controller 43 is connected to a secondary volume 44 and to a consistent data storage volume 48. The disk array controllers 23 and 43 copy the data of the primary volume 24 into the secondary volume 44 (remote copy).

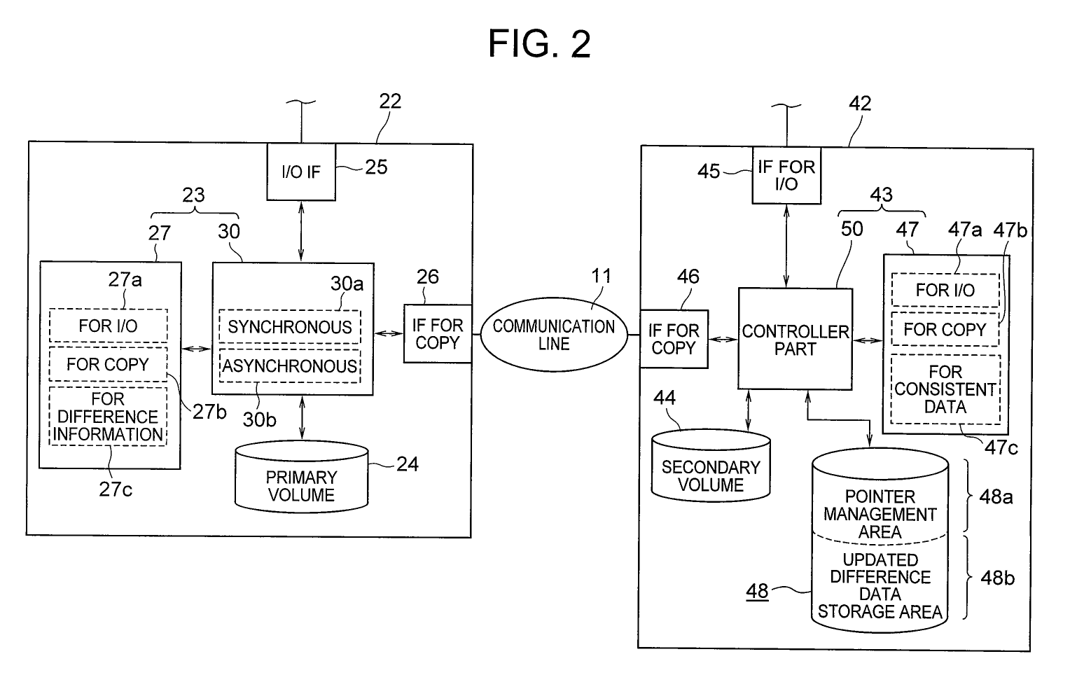

FIG. 2 is a block diagram showing an example of a hardware structure of the disk array unit of FIG. 1. This will be hereinafter described with reference to FIG. 1 and FIG. 2.

The main controller 22 includes an I/O communication interface 25 used to communicate with the higher-level host 21 and a copy communication interface 26 used to communicate with the communication line 11, in addition to the disk array controller 23 and the primary volume 24. The disk array controller 23 is divided into a cache memory unit 27 that temporarily stores various pieces of data and a main control unit 30 that executes a function by the main controller 22. The main control unit 30 makes combination use of a synchronous method 30a in which updated data is written and copied by synchronizing the primary volume 24 of the local site 20 with the secondary volume 44 of the remote site 40 and an asynchronous method in which updated data is written and copied in an asynchronous state between the primary volume 24 and the secondary volume 44. The main control unit 30 controllably performs switching between the synchronous method 30a and the asynchronous method 30b in an appropriate manner.

The cache memory unit 27 includes an I/O memory area 27a that stores data used between the higher-level host 21 and the primary volume 24, a copy memory area 27b that stores data used between the primary volume 24 and the secondary volume 44, and a difference information memory area 27c that stores difference information about data used between the primary volume 24 and the secondary volume 44.

The sub-controller 42 includes an I/O communication interface 45 used to communicate with the higher-level host 41 and a copy communication interface 46 used to communicate with the communication line 11, in addition to the disk array controller 43, the secondary volume 44, and the consistent data storage volume 48. The disk array controller 43 is divided into a cache memory unit 47 that temporarily stores various pieces of data and a main control unit 50 including a computer that fulfills various functions according to programs. The cache memory unit 47 includes an I/O memory area 47a, a copy memory area 47b, and a consistent data memory area 47c. The consistent data storage volume 48 includes a pointer management area 48a and an updated difference data storage area 48b.

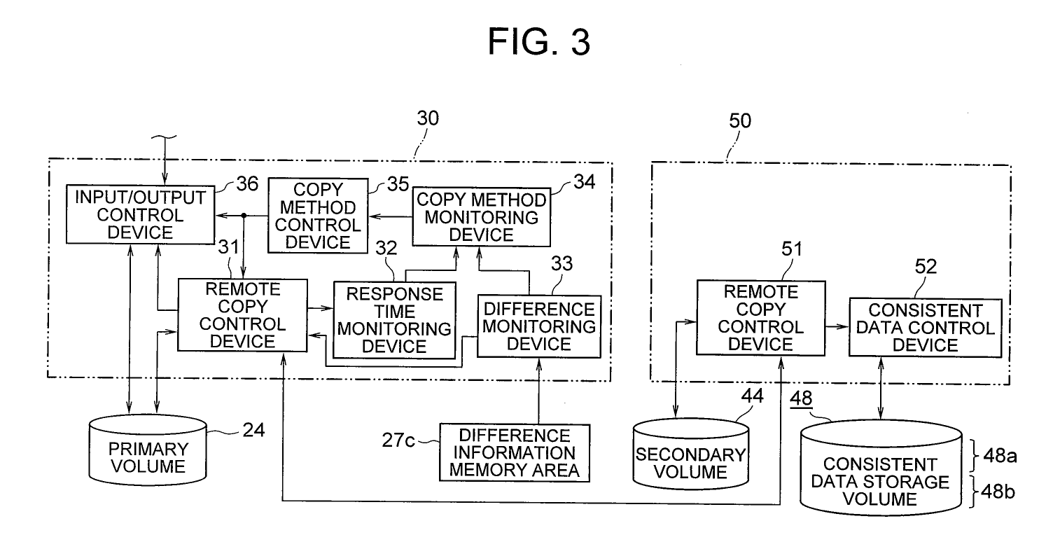

FIG. 3 is a block diagram showing an example of a function concerning the remote copy of the controller of FIG. 2. This will be hereinafter described with reference to FIG. 1 to FIG. 3.

The main control unit 30 disposed on the side of the primary volume 24 includes a remote copy control device 31, a response time monitoring device 32, a difference monitoring device 33, a copy method monitoring device 34, a copy method control device 35, and an input/output control device 36. The main control unit 50 disposed on the side of the secondary volume 44 includes a remote copy control device 51 and a consistent data control device 52. The remote copy control device 31 and 52 transmit data and commands necessary for each device concerning the remote copy.

The copy method control device 35 confirms a completion of an operation in which data updated in the primary volume 24 is copied into the secondary volume 44, and then employs at least one of the synchronous method 30a according to which the higher-level host 21 is informed of the completion of the writing of the updated data and the asynchronous method 30b according to which the higher-level host 21 is informed of the completion of the writing of the updated data as soon as data update is completed in the primary volume 24.

The input/output control device 36 updates the data of the primary volume 24 by a command emitted from the higher-level host 21 according to at least one of the synchronous method 30a and the asynchronous method 30b employed by the copy method control device 35. In the synchronous method 30a, information whether data updated in the primary volume 24 has been copied into the secondary volume 44 is obtained from the remote copy control devices 31 and 51.

The response time monitoring device 32 monitors a response time that is the time taken for a data copy operation performed to copy data into the secondary volume 44. The term “response time” denotes the time from when a date copy request is issued to the secondary volume 44 until when the host is informed of the fact that the data copy operation has been completed in the secondary volume 44. This response time is obtained from the remote copy control devices 31 and 51.

When the synchronous method 30a is employed by the copy method control device 35, and when the response time monitored by the response time monitoring device 32 exceeds a fixed time, the copy method monitoring device 34 allows the copy method control device 35 to employ the asynchronous method 30b in place of the synchronous method 30a.

In the synchronous method 30a, after the data of the primary volume 24 is updated, the completion of the copying of the updated data into the secondary volume is awaited, and then the higher-level host 21 is informed of the completion of the writing of the updated data. Therefore, if the time taken to copy the data into the secondary volume 44 becomes long, data update processing in the primary volume 24 will be delayed.

Therefore, a response time that is the time taken for data copy processing into the secondary volume 44 is monitored, and switching from the synchronous method 30a to the asynchronous method 30b is performed when the response time exceeds a fixed time. As a result, the higher-level host 21 is informed of the completion of the writing of the updated data without awaiting the completion of data copy into the secondary volume 44. Therefore, it is possible to overcome the disadvantage such that the reporting of the completion of the writing of the updated data into the primary volume 24 to the higher-level host 21 is delayed. At this time, switching to the asynchronous method 30b is performed based on a response time, not based on access frequency from the higher-level host 21 to the primary volume 24, and hence it is easy to solve the problem of a response delay caused by a band shortage of the communication line 11.

The main control unit 30 disposed on the side of the primary volume 24 additionally includes the difference monitoring device 33 that monitors a data difference amount that is the total difference between the data of the primary volume 24 and the data of the secondary volume 44. The “data difference amount” denotes the total amount of pieces of data that have not yet been copied in the secondary volume 44 (i.e., pieces of data that have not yet obtained a response time) among pieces of data that have been updated in the primary volume 24. These pieces of data that have not yet been copied in the secondary volume 44 are stored in the memory area 27c in the difference information memory area 27c.

At this time, the copy method monitoring device 34 allows the copy method control device 35 to employ the asynchronous method 30b instead of the synchronous method 30a. Thereafter, when the data difference amount monitored by the difference monitoring device 33 becomes smaller than a fixed amount, the copy method monitoring device 34 allows the copy method control device 35 to employ the asynchronous method 30b for data updated in the primary volume 24 before becoming smaller than the fixed amount, and allows the copy method control device 35 to employ the synchronous method 30a for data updated in the primary volume 24 after becoming smaller than the fixed amount.

If the band of the communication line 11 comes into a sufficient state after switching from the synchronous method 30a to the asynchronous method 30b, there is no need to continuously use the asynchronous method 30b. A data difference amount that is the total difference between the data of the primary volume 24 and the data of the secondary volume 44 is used as a criterion therefor. In other words, when the data difference amount becomes smaller than a fixed amount, the main control unit 30 allows the asynchronous method 30b to be continuously used for updated data in the primary volume 24, which are updated before the data difference amount becomes smaller than the fixed amount, and allows switching from the asynchronous method 30b to the synchronous method 30a so that the synchronous method 30a is used for updated data in the primary volume 24, which are updated after the data difference amount becomes smaller than the fixed amount. As a result, only the synchronous method 30a is automatically used when the data difference amount decreases and comes to zero. Therefore, it is possible to achieve a smooth shift from the asynchronous method 30b to the synchronous method 30a.

Additionally, in the main control unit 50 disposed on the side of the secondary volume 44, when the copy method control device 35 employs the asynchronous method 30b in place of the synchronous method 30a, the consistent data control device 52 stores the data of the secondary volume 44 immediately before this time in the consistent data storage volume 48. When the data difference amount monitored by the difference monitoring device 33 comes to zero, the consistent data control device 52 deletes the data stored in the consistent data storage volume 48. In the consistent data control device 52, a piece of information showing that switching to the asynchronous method 30b has been performed by the copy method control device 35 and the data difference amount monitored by the difference monitoring device 33 can be obtained through the remote control devices 31 and 51. Processing to store the data of the secondary volume 44 in the consistent data storage volume 48 is performed through the remote control device 51.

When the main control unit 30 of the main controller 22 performs switching from the synchronous method 30a to the asynchronous method 30b, the problem such that the reporting of the completion of the writing of the updated data into the primary volume 24 to the higher-level host 21 is delayed can be overcome, whereas data consistency is broken between the secondary volume 44 and the primary volume 24. As a result, if a disaster or the like occurs, a recovery using the secondary volume 44 cannot be guaranteed. Therefore, when the main controller 30 performs switching from the synchronous method 30a to the asynchronous method 30b, the main control unit 50 of the sub-controller 42 allows the data of the secondary volume 44 immediately before this time to be stored in the consistent data storage volume 48. Thereafter, when the data difference amount comes to zero, data consistency is established between the secondary volume 44 and the primary volume 24, and hence the main control unit 50 of the sub-controller 42 regards the data stored in the consistent data storage volume 48 as useless, and deletes this data. Therefore, if a disaster or the like occurs, a recovery using the secondary volume 44 can be guaranteed.

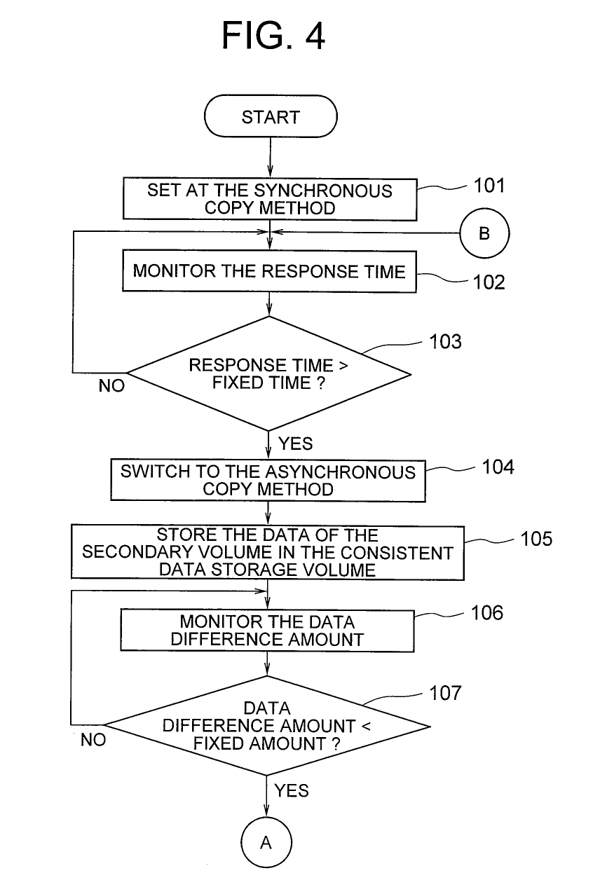

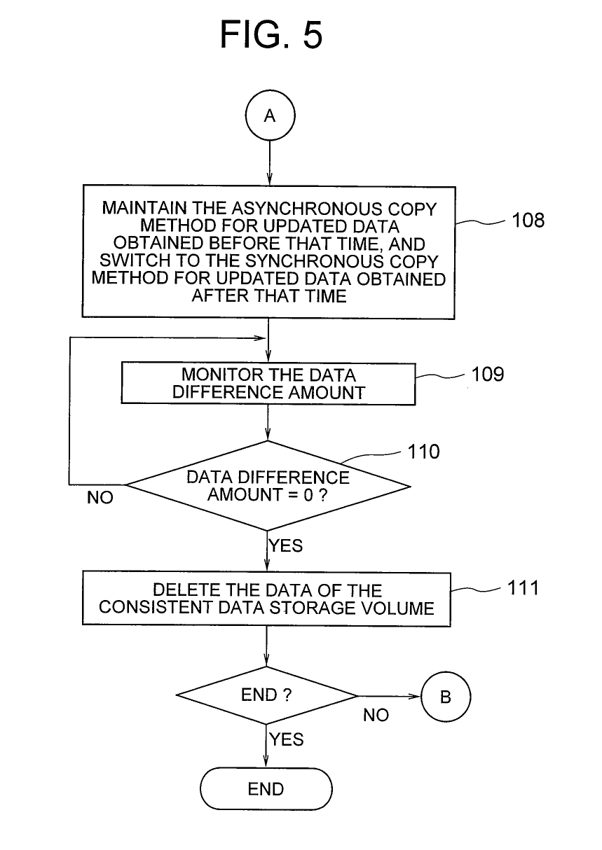

FIG. 4 and FIG. 5 are flow charts showing an example of an operation concerning the remote copy of the controller of FIG. 3. This will be hereinafter described with reference to FIG. 1 to FIG. 5.

First, the method is set as the synchronous method 30a (step 101). Thereafter, the response time is monitored (step 102). Thereafter, it is determined whether the response time exceeds the fixed time (step 103). As a result, to prevent a delay in the data update processing in the primary volume 24, which is caused when the response time exceeds the fixed time, switching from the synchronous method 30a to the asynchronous method 30b is performed (step 104). The data of the secondary volume 44 immediately before this time is stored in the consistent data storage volume 48, thereby preparing for a recovery by the secondary volume 44 (step 105). Thereafter, a data difference amount is monitored (step 106). Then, it is determined whether the data difference amount is smaller than the fixed amount (step 107). As a result, since a shortage of the band of the communication line 11 is being relieved when the data difference amount becomes smaller than the fixed amount, the asynchronous method 30b is continuously used for updated data in the primary volume 24 updated before this time, and switching to the synchronous method 30a is performed for updated data in the primary volume 24 updated after this time (step 108). Thereafter, the data difference amount is monitored (step 109). Then, it is determined whether the data difference amount is zero (step 110). As a result, since the data stored in the consistent data storage volume 48 becomes unnecessary when the data difference amount is zero, this data is deleted (step 111).

Next, an example of the remote copy method according to the exemplary embodiment of the invention will be described with reference to FIG. 1 to FIG. 5. The remote copy method according to this exemplary embodiment is the same as in the exemplary embodiment concerning the disk array controller and the other elements mentioned above. Herein, only the remote copy method according to this exemplary embodiment is extracted and described again.

The remote copy method according to this exemplary embodiment is used in the remote copy system 10 in which the main controller 22 including the primary volume 24 in the local site 21 is connected to the higher-level host 21 and in which the sub-controller 42 including the secondary volume 44 in the remote site 40 is connected to the main controller 22 through the communication line 11. According to this remote copy method, the data of the primary volume 24 is copied into the secondary volume 44.

The remote copy method is based on the assumption that the remote copy method employs at least one of the synchronous method 30a and the asynchronous method 30b. In the synchronous method 30a, data is updated in the primary volume 24 and is copied into the secondary volume 44, and the higher-level host 21 of the local site 20 is informed of the completion of the data copy processing when the data copy processing into the secondary volume 44 is completed. In the asynchronous method 30b, the higher-level host 21 is informed of the completion of the writing of updated data as soon as data update is completed in the primary volume 24.

According to at least one of the synchronous method 30a and the asynchronous method 30b employed thereby, the data of the primary volume 24 is updated by a command issued from the higher-level host 21. When the updated data is copied into the secondary volume 44, a response time that is the time taken to copy the data into the secondary volume 44 is monitored. At this time, the synchronous method 30a is employed, and, when the response time being monitored exceeds a fixed time, the asynchronous method 30b is employed instead of the synchronous method 30a.

In the remote copy method according to this exemplary embodiment, a data difference amount that is the total difference between the data of the primary volume 24 and the data of the secondary volume 44 is monitored, and the asynchronous method 30b is employed instead of the synchronous method 30a. Thereafter, when the data difference amount being monitored becomes smaller than a fixed amount, the asynchronous method 30b is employed for updated data in the primary volume 24 which are updated before the data difference amount becomes smaller than the fixed amount, whereas the synchronous method 30a is employed for updated data in the primary volume 24 which are updated after the data difference amount becomes smaller than the fixed amount.

Additionally, when the asynchronous method 30b is employed instead of the synchronous method 30a, the data of the secondary volume 44 immediately before this time is stored in the consistent data storage volume 48. When the data difference amount being monitored comes to zero, the data stored in the consistent data storage volume 48 is deleted.

The operation and effect of the remote copy method according to this exemplary embodiment are the same as those of the disk array controller and the other elements according to the above-mentioned exemplary embodiment.

Next, an example of a control program used for the remote copy system according to the exemplary embodiment of the invention will be described with reference to FIG. 1 to FIG. 5. The control program according to this exemplary embodiment is to cause a computer to execute functions performed by the disk array controller and the other elements according to the above-mentioned exemplary embodiment.

The control program according to this exemplary embodiment is used for the remote copy system 10, and is used to cause a computer to execute the function to copy the data of the primary volume 24 into the secondary volume 44. In the remote copy system 10 including the computer, the main controller 22 including the primary volume 24 is connected to the higher-level host 21, and the sub-controller 42 including the secondary volume 44 is connected to the main controller 22 through the communication line 11.

For example, this computer forms the main control units 30 and 50. The control program according to this exemplary embodiment is characterized by the following structure. The control program allows the computer to execute functions performed by the copy method control device 35 that employs at least one of the synchronous method 30a, in which data is updated in the primary volume 24 and is copied into the secondary volume 44 and in which the higher-level host 21 of the local site 20 is informed of the completion of the copy operation when the updated data is copied into the secondary volume 44, and the asynchronous method 30b, in which the higher-level host 21 is informed of the completion of the writing of updated data as soon as data update is completed in the primary volume 24; the input/output control device 36 that updates the data of the primary volume 24 according to a command issued from the higher-level host 21 according to at least one of the synchronous method 30a and the asynchronous method 30b employed by the copy method control device 35; the response time monitoring device 32 that monitors a response time that is the time taken to copy the data into the secondary volume 44; and the copy method monitoring device 34 that allows the copy method control device 35 to employ the asynchronous method 30b instead of the synchronous method 30a, when the synchronous method 30a has been employed by the copy method control device 35 and then the response time being monitored by the response time monitoring device 32 exceeds a fixed time.

Additionally, the control program according to this exemplary embodiment further causes the computer to function the difference monitoring device 33 that monitors a data difference amount that is the total difference between the data of the primary volume 24 and the data of the secondary volume 44. The control program controls the computer so that the copy method control device 35 employs the asynchronous method 30b instead of the synchronous method 30a, and thereafter, when the data difference amount being monitored by the difference monitoring device 33 becomes smaller than a fixed amount, the copy method control device 35 employs the asynchronous method 30b for updated data in the primary volume 24, which are updated before the data difference amount becomes smaller than the fixed amount, whereas the copy method control device 35 employs the synchronous method 30a for updated data in the primary volume 24, which are updated after the data difference amount becomes smaller than the fixed amount.

Additionally, the control program according to this exemplary embodiment is used for a computer forming the sub-controller 42. The sub-controller 42 additionally includes the consistent data storage volume 48. When the copy method control device 35 employs the asynchronous method 30b instead of the synchronous method 30a, the data of the secondary volume 44 immediately before employing the asynchronous method 30b is stored in the consistent data storage volume 48. When the data difference amount being monitored by the difference monitoring device 33 comes to zero, the computer is caused to execute the function performed by the consistent data control device 52 that deletes data stored in the consistent data storage volume 48.

The operation and effect of the control program according to this exemplary embodiment are the same as those of the disk array controller and the other elements according to the above-mentioned exemplary embodiment.

Next, the exemplary embodiment of the present invention will be described in more detail with reference to FIG. 1 to FIG. 5.

In the remote copy method between the controllers 22 and 42, a main part is formed by connecting the local site 20 including the main controller 22 and the higher-level host 21 to the remote site 40 including the sub-controller 42 and the higher-level host 41 through the communication line 11. The main controller 22 includes the disk array controller 23 and the primary volume 24. The sub-controller 42 includes the disk array controller 43, the secondary volume 44, and the consistent data storage volume 48.

In the local site 20, the input/output control device 36 controls a response to the higher-level host 21 according to a copy method (i.e., synchronous method 30a/asynchronous method 30b) when an updated-data-write request is issued from the higher-level host 21 to the primary volume 24. The remote copy control device 31 has the following function, in addition to the function to copy the data of the primary volume 24 into the secondary volume 44. A piece of information that the writing of updated data into the secondary volume 44 has been completed is received, and is output to the input/output control device 36 and the response time monitoring device 32. The data difference amount held in the difference information memory area 27c is input from the difference monitoring device 33, and the copy method employed by the copy method control device 35 is input. This information is transmitted to the consistent data control device 211. The difference information memory area 27c manages address information about difference data generated in the primary volume 24 and the secondary volume 44 during the operation of the asynchronous method 30b.

In the remote site 40, when it is detected that switching has been performed from the synchronous method 30a to the asynchronous method 30b, the consistent data control device 52 allows the data image of the secondary volume 44 obtained immediately before the switching to the asynchronous method 30b, i.e., during the operation of the synchronous method 30a to be stored in the consistent data storage volume 48. When it is detected that only the synchronous method 30a has been used from the fact that the data difference amount of the difference information memory area 27c has come to zero, the data of the consistent data storage volume 48 is deleted.

The main control unit 30 is composed of the remote copy control device 31, the response time monitoring device 32, the difference monitoring device 33, the copy method monitoring device 34, and the copy method control device 35. The copy method control device 35 controls the copy method (synchronous method 30a/asynchronous method 30b) with respect to the input/output control device 36. During the operation of the synchronous method 30a, the response time monitoring device 32 monitors a response time taken until information that the writing of updated data into the secondary volume 44 has been completed is reported. If the information of the completion is not reported within a fixed time (predetermined time), the response time monitoring device 32 determines that a response has been delayed, and issues a command to perform switching from the synchronous method 30a to the asynchronous method 30b toward the copy method control device 35 through the copy method monitoring device 34. The difference monitoring device 33 monitors the data difference amount of the difference information memory area 27c. When the data difference amount becomes smaller than a fixed amount (predetermined amount), the difference monitoring device 33 issues a command that the writing of the data from the higher-level host 21 is to be performed according to the synchronous method 30a after the data difference amount becomes smaller than the fixed amount (predetermined amount) toward the copy method control device 35 through the copy method monitoring device 34. The copy method control device 35 allows parallel processing using both the synchronous method 30a and the asynchronous method 30b until the data difference amount of the difference information memory area 27c becomes smaller than the fixed amount and reaches zero.

Next, the operation according to the exemplary embodiment of the invention will be described in more detail with reference to FIG. 1 to FIG. 5.

First, a description will be given of the operation concerning two remote copy methods that are important elements of the present invention, i.e., the operation concerning the synchronous method 30a and the asynchronous method 30b.

In the synchronous method 30a, when a write request to write a piece of updated data is issued from the higher-level host 21 to the primary volume 24, the data of the primary volume 24 is updated, and this updated data is immediately transmitted to the disk array unit 42 of the remote site 40 through the communication line 11. In the disk array unit 42 of the remote site 40, this updated data is written into the secondary volume 44. When the writing of the updated data is completed, the disk array unit 22 of the local site 20 is informed of the completion of the writing of the updated data. The disk array unit 22 of the local site 20 receives a completion report from the disk array unit 42 of the remote site 40, and gives this completion report to the higher-level host 21.

On the other hand, in the asynchronous method 30b, when a write request to write a piece of updated data is issued from the higher-level host 21 to the primary volume 24, a completion report is given to the higher-level host 21 upon completion of the update of the data of the primary volume 24. Address information of the updated data obtained at this time is registered in the difference information memory area 27c as a difference with the secondary volume 44. Thereafter, the updated data is asynchronously written from the primary volume 24 to the secondary volume 44 based on the information registered in the difference information memory area 27c.

This is a description of the two remote copy methods. Next, the entire operation in the exemplary embodiment will be described.

First, in average I/O traffic, the remote copy between the local site 20 and the remote site 40 is operated according to the synchronous method 30a. At this time, the input/output control device 36 in the local site 20 controls a response to the higher-level host 21 according to the copy method (synchronous method 30a/asynchronous method 30b) with respect to an updated-data write request from the higher-level host 21 to the primary volume 24.

When a write request to write updated data exceeding the band of the communication line 11 is issued from the higher-level host 21 to the primary volume 24 in this state, the copy method monitoring device 34 orders the copy method control device 35 to perform switching from the synchronous method 30a to the asynchronous method 30b if the response time monitoring device 32 detects that information that the writing of updated data has been completed has not been given from the secondary volume 44 within a fixed time. The copy method control device 35 that has received this command allows the input/output control device 36 to start processing according to the asynchronous method 30b.

The copy method monitoring device 34 transmits the fact that a state transition to the asynchronous method 30b has been made therefrom to the consistent data control device 52 as a state transition notice. When the consistent data control device 52 receives this notice, the data image of the secondary volume 44 obtained in the synchronous method 30a is stored in the consistent data storage volume 48. This makes it possible to secure consistent data that can be restored when a disaster occurs during the operation of the asynchronous method 30b.

The consistent data storage volume 48 is divided into a pointer management area 48a and an updated difference data storage area 48b. These areas are used to store the data image of the secondary volume 44, and are not required to have the same capacity as the secondary volume 44. These areas store a pointer in the synchronous method 30a immediately before switching to the asynchronous method 30b and data that has been updated in the secondary volume 44 during the operation of the asynchronous method 30b from the time when the synchronous method 30a was used.

It is assumed that the updated-data write request issued from the higher-level host 21 to the primary volume 24 is decreased during the operation of the asynchronous method 30b, and, as a result, becomes smaller than the band of the communication line 30, and the data difference amount registered in the difference information memory area 27c becomes smaller than a fixed amount. If so, this state is detected by the difference monitoring device 33, and the copy method monitoring device 34 orders the copy method control device 35 to perform processing according to the synchronous method 30a for the updated-data write request issued from the higher-level host 21. The copy method control device 35 that receives this command allows the input/output control device 36 to start processing according to the synchronous method 30a. Therefore, the copy method control device 35 allows parallel processing using the synchronous method 30a and the asynchronous method 30b until the data difference amount of the difference information memory area 27c becomes smaller than the fixed amount and reaches zero.

When the data difference amount of the difference information memory area 27c reaches zero, the asynchronous method 30b is ended, and the synchronous method 30a is completely started. Accordingly, the copy method monitoring device 34 transmits the fact that a state transition to the synchronous method has been completely made therefrom to the consistent data control device 52 as a state transition notice. The consistent data control device 52 that has received this notice deletes the data stored in the consistent data storage volume 48.

Thus, it becomes possible to provide a fault-tolerant remote copy method based on the synchronous method 30a that can endure a temporary increase in I/O traffic during the remote copy operation.

Next, effects of this exemplary embodiment will be described in detail.

According to the invention, a response time that is the time taken for data copy processing into the secondary volume is monitored, and switching from the synchronous method to the asynchronous method is performed when the response time exceeds a fixed time. Therefore, as an exemplary advantage according to the invention, it is possible to overcome the disadvantage such that the reporting of the completion of the writing of the updated data to the higher-level host is delayed. At this time, switching to the asynchronous method is performed based on the response time, not based on access frequency from the higher-level host to the primary volume, and hence it is easy to solve the problem of a response delay caused by a band shortage of the communication line.

An effect of this exemplary embodiment is as follows. When temporary I/O traffic from the higher-level host 21 to the primary volume 24 of the local site 20 is increased, and exceeds an assumed tolerance, which is set when the system is designed, during a remote copy operation, the remote copy operation in which consistent data is secured can be continuously performed without lowering the performance of the higher-level host 21 in using the synchronous method 30a that has a possibility that the performance of the higher-level host 21 will be lowered. The reason is as follows. If notice that the writing of updated data has been completed which is given from the logical disk of the remote site 40 is delayed because of an increase in temporary I/O traffic to the logical disk of the local site 20 during the operation of the synchronous method 30a, switching to the asynchronous method 30b is performed to prevent a temporary fall in the performance of the higher-level host 21, and priority is given to I/O from the higher-level host 21. Simultaneously, consistent data obtained in the synchronous method 30a is stored. If I/O traffic falls within the tolerance of the band of the communication line, which is set when the system is designed, and, as a result, a delay in the remote copy operation is eliminated, it will become possible to continuously perform the remote copy operation maintaining the data consistency by being returned to the synchronous method 30a.

Although a case in which the exemplary embodiment of the invention is constructed as a remote copy system has been described above, a case in which the exemplary embodiment of the invention is constructed as a disk array system will be described hereinafter.

The disk array system according to the exemplary embodiment of the invention is used in a disk array system in which a first disk array unit including a primary volume in a local site is connected to a higher-level host, and a second disk array unit including a secondary volume in a remote site is connected to the first disk array unit through a communication line. The disk array system according to the exemplary embodiment of the invention has a function to copy the data of the primary volume into the secondary volume. A disk array controller according to the exemplary embodiment of the invention is characterized by including a copy method control device that employs at least one of a synchronous method according to which data is updated in the primary volume and is copied into the secondary volume and, when information that the copying of the data has been completed is given, the higher-level host of the local site is informed of the completion of the writing of the updated data if an updated-data write request is issued from the higher-level host to the primary volume in the local site and an asynchronous method according to which the higher-level host of the local site is informed of the completion of the writing of the updated data as soon as data update is completed in the primary volume; an input/output control device that updates the data of the primary volume based on a command issued from the higher-level host according to at least one of the synchronous method and the asynchronous method employed by the copy method control device; a response time monitoring device that monitors a response time that is the time taken to copy the data into the secondary volume; and a copy method monitoring device that allows the copy method control device to employ the asynchronous method instead of the synchronous method, when the synchronous method has been employed by the copy method control device and then the response time being monitored by the response time monitoring device exceeds a fixed time.

In the synchronous method, after the data of the primary volume is updated, the completion of the copying of the updated data into the secondary volume is awaited, and then the higher-level host of the local site is informed of the completion of the writing of the updated data. Therefore, if the time taken to copy the data into the secondary volume becomes long, an updated-data completion report will be delayed to be sent to the higher-level host. Therefore, a response time that is the time taken for data-copy processing into the secondary volume is monitored, and switching from the synchronous method to the asynchronous method is performed when the response time exceeds a fixed time. As a result, the higher-level host of the local site is informed of the completion of the writing of the updated data without awaiting the completion of data copy in the secondary volume as soon as data update in the primary volume is completed. Therefore, it is possible to overcome the disadvantage such that the reporting of the completion of the writing of the updated data to the higher-level host of the local site is delayed. At this time, switching to the asynchronous method is performed based on a response time that is the time taken for data-copy processing, not based on access frequency from the higher-level host to the primary volume, and hence it is easy to solve the problem such that the reporting of the completion of the writing of the updated data to the higher-level host is delayed, which is caused by a band shortage of the communication line.

The disk array system according to the exemplary embodiment of the invention may further include a difference monitoring device that monitors a data difference amount that is the total difference between the data of the primary volume and the data of the secondary volume. The copy method monitoring device may have a function to, when the data difference amount being monitored by the difference monitoring device becomes smaller than a fixed amount after allowing the copy method control device to employ the asynchronous method instead of the synchronous method, allow the copy method control device to employ the asynchronous method for updated data in the primary volume, which are updated before the data difference amount becomes smaller than the fixed amount, and allow the copy method control device to employ the synchronous method for updated data in the primary volume, which are updated after the data difference amount becomes smaller than the fixed amount.

If the band of the communication line reaches a sufficient state after switching from the synchronous method to the asynchronous method, there is no need to continuously use the asynchronous method. A data difference amount that is the total difference between the data of the primary volume and the data of the secondary volume is used as a criterion therefor. In other words, when the data difference amount becomes smaller than a fixed amount, the asynchronous method is allowed to be continuously used for updated data in the primary volume, which are updated before the data difference amount becomes smaller than the fixed amount, and switching from the asynchronous method to the synchronous method is performed so that the synchronous method is used for updated data in the primary volume, which are updated after the data difference amount becomes smaller than the fixed amount. As a result, only the synchronous method is automatically used when the data difference amount decreases and reaches zero. Therefore, it is possible to achieve a smooth shift from the asynchronous method to the synchronous method.

The disk array system according to the exemplary embodiment of the invention may include a consistent data storage volume and a consistent data control device which are mounted in the second disk array unit when the disk array controller according to the present invention is mounted in the first disk array unit. The consistent data control device may have a function to, when the copy method control device employs the asynchronous method instead of the synchronous method, store the data of the secondary volume obtained immediately before employing the asynchronous method in the consistent data storage volume, and delete the data stored in the consistent data storage volume when the data difference amount monitored by the difference monitoring device reaches zero.

When switching from the synchronous method to the asynchronous method is performed, the problem such that the reporting of the completion of the writing of the updated data to the higher-level host of the local site is delayed can be resolved, whereas data consistency is broken between the secondary volume and the primary volume. As a result, if a disaster occurs, a recovery using the secondary volume cannot be guaranteed. Therefore, when switching from the synchronous method to the asynchronous method is performed, the data of the secondary volume obtained immediately before switching to the asynchronous method is allowed to be stored in the consistent data storage volume. Thereafter, when the data difference amount reaches zero, data consistency is established between the secondary volume and the primary volume, and hence the data stored in the consistent data storage volume is regarded as useless, and is deleted. Therefore, if a disaster or the like occurs, a recovery using the secondary volume can be guaranteed.

The disk array system according to the exemplary embodiment of the invention is characterized by including the first disk array unit, the second disk array unit, and a disk array controller according to the present invention. According to the disk array system according to the present invention, the use of the disk array controller according to the present invention makes it possible to resolve the problem such that the reporting of the completion of the writing of the updated data to the higher-level host of the local site is delayed, which is caused by a band shortage of the communication line. Therefore, it is possible to endure a temporary increase in I/O traffic that exceeds an assumed tolerance, which is estimated when the system is designed, during the system remote copy operation.

The disk array control method according to the exemplary embodiment of the invention is used in a disk array system in which a first disk array unit including a primary volume in a local site is connected to a higher-level host, and a second disk array unit including a secondary volume in a remote site is connected to the first disk array unit through a communication line. The disk array control method according to the exemplary embodiment of the invention is to copy the data of the primary volume into the secondary volume. The disk array control method is characterized by being based on the assumption that, when an updated-data-write request is issued from the higher-level host to the primary volume in the local site, the disk array control method employs at least one of a synchronous method in which data is updated in the primary volume and is copied into the secondary volume and in which the higher-level host of the local site is informed of the completion of the data copy processing when a report that the data copy processing into the secondary volume has been completed is given and an asynchronous method in which the higher-level host of the local site is informed of the completion of the writing of updated data as soon as the writing of updated data is completed in the primary volume; is characterized in that the data of the primary volume is updated by a command issued from the higher-level host according to at least one of the synchronous method and the asynchronous method employed thereby; is characterized in that a response time that is the time taken to complete the copy of the data into the secondary volume is monitored when the updated data is copied into the secondary volume; and is characterized in that the asynchronous method is employed instead of the synchronous method, when the synchronous method has been employed and then the response time being monitored exceeds a fixed time.

The disk array control method according to the exemplary embodiment of the invention may be structured so that a data difference amount that is the total difference between the data of the primary volume and the data of the secondary volume is monitored, and the asynchronous method is employed instead of the synchronous method, and thereafter, when the data difference amount being monitored becomes smaller than a fixed amount, the asynchronous method is employed for updated data in the primary volume, which are updated before the data difference amount becomes smaller than the fixed amount, whereas the synchronous method is employed for updated data in the primary volume, which are updated after the data difference amount becomes smaller than the fixed amount.

The disk array control method according to the exemplary embodiment of the invention may be used for the second disk array unit when the disk array control method according to the present invention is used for the first disk array unit. The second disk array unit may include a consistent data storage volume, and, when the asynchronous method is employed instead of the synchronous method, the data of the secondary volume obtained immediately before employing the asynchronous method may be stored in the consistent data storage volume, and the data stored in the consistent data storage volume may be deleted when the data difference amount being monitored reaches zero.

The disk array control program according to the exemplary embodiment of the invention is used in a disk array system having a computer in which a first disk array unit including a primary volume in a local site is connected to a higher-level host and in which a second disk array unit including a secondary volume in a remote site is connected to the first disk array unit through a communication line. The disk array control program according to the exemplary embodiment of the invention causes the computer to perform a function to copy the data of the primary volume into the secondary volume. The disk array control program according to the present invention is characterized by causing the computer to operate a copy method control device that employs at least one of a synchronous method according to which data is updated in the primary volume and is copied into the secondary volume and, when information that the copying of the data has been completed is given, the higher-level host of the local site is informed of the completion of the copying of the updated data if an updated-data write request is issued from the higher-level host to the primary volume in the local site and an asynchronous method according to which the higher-level host of the local site is informed of the completion of the writing of the updated data as soon as data update is completed in the primary volume; an input/output control device that updates the data of the primary volume according to a command issued from the higher-level host according to at least one of the synchronous method and the asynchronous method employed by the copy method control device; a response time monitoring device that monitors a response time that is the time taken to copy the data into the secondary volume; and a copy method monitoring device that allows the copy method control device to employ the asynchronous method instead of the synchronous method, when the synchronous method has been employed by the copy method control device and then the response time being monitored by the response time monitoring device exceeds a fixed time.

The disk array control program according to the exemplary embodiment of the invention may further cause the computer to operate a difference monitoring device that monitors a data difference amount that is the total difference between the data of the primary volume and the data of the secondary volume, and may cause the computer to employ the copy method monitoring device so that, when the data difference amount being monitored by the difference monitoring device becomes smaller than a fixed amount after allowing the copy method control device to employ the asynchronous method instead of the synchronous method, the copy method control device is allowed to employ the asynchronous method for updated data in the primary volume, which are updated before the data difference amount becomes smaller than the fixed amount, whereas the copy method control device is allowed to employ the synchronous method for updated data in the primary volume, which are updated after the data difference amount becomes smaller than the fixed amount.

When the first and second disk array units include computers, respectively, and when the disk array control program according to the present invention is used for the computer of the first disk array unit, the disk array control program according to the exemplary embodiment of the invention may be used for the computer of the second disk array unit. The second disk array unit additionally includes a consistent data storage volume, and the computer of the second disk array unit may be allowed to function a consistent data control device by which, when the copy method control device employs the asynchronous method instead of the synchronous method, the data of the secondary volume obtained immediately before employing the asynchronous method is stored in the consistent data storage volume and by which, when the data difference amount being monitored by the difference monitoring device reaches zero, the data stored in the consistent data storage volume is deleted.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A remote copy system in which updated data is written into a primary volume of a local site, and data written in the primary volume is copied into a secondary volume of a remote site by making combination use of a synchronous method according to which updated data is written and copied while synchronizing the primary volume of the local site with the secondary volume of the remote site and an asynchronous method according to which updated data is written and copied under an asynchronous state between the primary volume and the secondary volume,
the remote copy system including a main controller that performs control to write updated data into the primary volume and a sub-controller that performs control to write data of the primary volume into the secondary volume,
wherein the main controller performs switching from the synchronous method to the asynchronous method when a data write time taken to write data into the secondary volume exceeds a predetermined value,
wherein combination use of the synchronous method and the asynchronous method and switching from the asynchronous method to the synchronous method are controlled according to a difference between a data amount of the primary volume and a data amount of the secondary volume, and
wherein the sub-controller controls a copy operation performed to copy the updated data under control performed by the main controller.

2. The remote copy system of claim 1, wherein the main controller performs switching from the synchronous method to the asynchronous method if information that the writing of the data has been completed is not received from the secondary volume within a predetermined time.

3. The remote copy system of claim 1, wherein, when the main controller controllably performs switching from the synchronous method to the asynchronous method, the sub-controller stores the data of the secondary volume obtained in a synchronous state immediately before changing into the asynchronous method.

4. The remote copy system of claim 3, wherein the sub-controller stores the data in the form of a data image.

5. The remote copy system of claim 1, wherein the main controller detects that a data difference amount between the primary volume and the secondary volume has become smaller than a predetermined amount, and performs processing for the writing of the updated data into the primary volume according to the synchronous method, and
the main controller performs parallel processing using the synchronous method and the asynchronous method until the data difference amount reaches zero.

6. The remote copy system of claim 3, wherein the sub-controller deletes the stored data when the data difference amount between the primary volume and the secondary volume reaches zero and, as a result, switching is performed from the asynchronous method to the synchronous method.

7. A disk array unit built in a remote copy system, the remote copy system used to write updated data into a primary volume of a local site and used to copy data written in the primary volume into a secondary volume of a remote site,
the disk array unit including a main controller that performs control to write updated data into the primary volume by making combination use of a synchronous method according to which updated data is written and copied while synchronizing the primary volume with the secondary volume and an asynchronous method according to which updated data is written and copied under an asynchronous state between the primary volume and the secondary volume,
wherein the main controller performs switching from the synchronous method to the asynchronous method when a data write time taken to write data into the secondary volume exceeds a predetermined value, and
wherein combination use of the synchronous method and the asynchronous method and switching from the asynchronous method to the synchronous method are controlled according to a difference between a data amount of the primary volume and a data amount of the secondary volume

8. The disk array unit of claim 7, wherein the main controller performs switching from the synchronous method to the asynchronous method if information that the writing of the data has been completed is not received from the secondary volume within a predetermined time.

9. The disk array unit of claim 7, wherein the main controller detects that a data difference amount between the primary volume and the secondary volume has become smaller than a predetermined amount, and performs processing for the writing of the updated data into the primary volume according to the synchronous method, and the main controller performs parallel processing using the synchronous method and the asynchronous method until the data difference amount reaches zero.

10. A disk array unit built in a remote copy system, the remote copy system used to write updated data into a primary volume of a local site and used to copy data written in the primary volume into a secondary volume of a remote site,
the disk array unit including a sub-controller combined with a main controller, the main controller controllably performing switching between a synchronous method according to which updated data is written and copied while synchronizing the primary volume with the secondary volume and an asynchronous method according to which updated data is written and copied under an asynchronous state between the primary volume and the secondary volume,
wherein the sub-controller performs control to copy the data written in the primary volume into the secondary volume of the remote site under control performed by the main controller, and
wherein when the main controller controllably performs switching from the synchronous method to the asynchronous method, the sub-controller stores the data of the secondary volume obtained in a synchronous state immediately before changing into the asynchronous method.

11. The disk array unit of claim 10, wherein the sub-controller stores the data in the form of a data image.

12. The disk array unit of claim 10, wherein the sub-controller deletes the stored data when the data difference amount between the primary volume and the secondary volume reaches zero and, as a result, switching is performed from the asynchronous method to the synchronous method.

13. A remote copy method in which updated data is written into a primary volume of a local site, and data written in the primary volume is copied into a secondary volume by making combination use of a synchronous method according to which updated data is written and copied while synchronizing the primary volume of the local site with the secondary volume of the remote site and an asynchronous method according to which updated data is written and copied under an asynchronous state between the primary volume and the secondary volume,
wherein switching from the synchronous method to the asynchronous method is performed when a data write time taken to write data into the secondary volume exceeds a predetermined value, and
wherein combination use of the synchronous method and the asynchronous method and switching from the asynchronous method to the synchronous method are controlled according to a difference between a data amount of the primary volume and a data amount of the secondary volume.

14. A control program used for a remote copy system, the remote copy system used to write updated data into a primary volume of a local site and used to copy data written in the primary volume into a secondary volume of a remote site,
the control program causing a computer to execute
a function to perform switching from a synchronous method according to which updated data is written and copied while synchronizing the primary volume with the secondary volume to an asynchronous method according to which updated data is written and copied under an asynchronous state between the primary volume and the secondary volume when a data write time taken to write data into the secondary volume exceeds a predetermined value, and
a function to control combination use of the synchronous method and the asynchronous method and switching from the asynchronous method to the synchronous method according to a difference between a data amount of the primary volume and a data amount of the secondary volume.
